(19) United States
(12) Patent Application Publication
(10) Pub. No.: US 2017/0098266 A1
(43) Pub. Date: Apr. 6, 2017

(54) Real-time local marketplace information system and method

(71) Applicant: Transcona Media Network Inc., Vancouver (CA)

(72) Inventor: Gary Taylor, Vancouver (CA)

(21) Appl. No.: 14/949,793

(22) Filed: Nov. 23, 2015

Related U.S. Application Data
(60) Provisional application No. 62/236,602, filed on Oct. 2, 2015.

(51) Int. Cl. G06Q 30/06

(52) U.S. Cl. CPC G06Q 30/0625; G06Q 30/0641

(57) ABSTRACT

Many local, brick-and-mortar businesses are losing out to large, de-localized online suppliers due, for example, to the overhead cost structure enabled by the world wide web. To address this problem, local business listings are provided to users concurrently with real time or near real time updates from those businesses. Users are presented with the identification of such businesses and their latest news, including offers, on a single web page, which eliminates the need for users to perform multiple searches and reduces the reliance of small businesses on strategies such as search engine optimization. A local map may also be displayed concurrently, and users may communicate with the businesses.

### CROSS-REFERENCE TO RELATED APPLICATIONS

This application claims the benefit of U.S. provisional patent application Ser. No. 62/236,602, filed on Oct. 2, 2015, which is incorporated by reference herein in its entirety.

### TECHNICAL FIELD

This application relates to a method and system for presenting marketplace information to users. In particular, it relates to providing local business listings to users concurrently with updates from those businesses in real time.

### BACKGROUND

The current state of the local search technology market is driven by the pursuit to deliver the highest degree of economic value for local businesses and shoppers as a means to generate the highest economic value for local search providers. Each local search provider seeks to offer the optimal service for generating customer loyalty from local businesses and shoppers to maximize the revenue-generating potential of their service. An undesired consequence of the competition between local search providers is the current fractionalized state of the local search market.

In the current fractionalized state of the local search market, local businesses are forced to identify and execute multiple strategies to be found online by local shoppers. Such strategies may include listing in multiple directories, optimizing their websites, writing a blog, tweeting, responding to online queries, emailing customers, offering deals through online social shopping sites, etc. Local shoppers are forced to identify multiple strategies for assembling local market information to help them make more informed purchase decisions. This may include, for example, performing multiple searches, performing increasingly focused searches, consulting directories, visiting independent review sites, etc. Local businesses and shoppers may “game the system” with neither party advancing significantly beyond the current state of perpetual searching, to a more efficient state, where the reliance on multiple search strategies diminishes over time.

Current local search technologies are severely limited in their ability to provide true economic value for local businesses and shoppers by focusing on “search” as their primary value driver. The following conditions are found in the current state of the local search technology market:

Current local search technology is inefficient for both shoppers and businesses at delivering comprehensive, accurate, local market information.

Current local search technology focuses on applying algorithms (See, for example: US 2011/0313954) designed to deliver more accurate business listing results based on a range of shopper attributes that are determined by tracking their online activities, location and preferences.

Current local search technology is focused on providing users with search interface tools for conducting key word and category-specific searches to deliver lists of static business information.

Current local search technology revenue models are focused on charging businesses fees to be found in their business category search results. Premium fees are charged to businesses so that they can be found ahead of their competitors in search results.

Current local search technologies are limited in their ability to unlock the full potential of additional revenue drivers beyond search-based drivers.

Current local search technologies fail to improve the efficiency of local markets to the same degree that traditional search technology improves the economic efficiency for large online marketplaces, which is due in part to the international nature of the internet and world wide web. The result is that local (de-centralized) marketplaces are becoming highly centralized around large online national and international marketplaces. The impact is that there is a significant shift away from local spending toward online spending with centralized marketplaces and money is leaving local economies, negatively impacting local employment and incomes. The internet and world wide web are therefore not functioning efficiently in relation to the provision of information relating to businesses on a local level.

It is the inventor's belief that the popularity of mobile phone usage for local searches is driven by the lack of suitable local search resources that enable shoppers to effectively find, organize and plan their local shopping strategies before going out into the marketplace. They are dependent on their mobile phones for finding and planning their local shopping activities while they are mobile, and are therefore less inclined to conduct thorough planning strategies. They “wing it” with their mobile phone to find a non-ideal set of options recommended by local search technologies. The same shoppers who rely on their mobile phones likely would not conduct their daily work using a mobile phone because the interface is too small to confidently navigate their way through the potential large amounts of data.

U.S. Patent Application Publication No. 2011/0313954 to Zhao et al. discloses a community model based point of interest local search platform. When a user queries the search platform, contextual parameters are submitted with the query and the corresponding point of interest information is displayed to the user.

U.S. Patent Application Publication No. 2009/0307018 to Chappell describes the presentation of listings according to levels of user interest in the listings. For example, statistics generated from tracking user interactions with the listings and/or other parameters can be used to measure or estimate a level of current user interest in a listing. Listings in search results can be presented in an order according to the levels of current user interest in the listings.

U.S. Pat. No. 9105032 to Altberg et al. discloses the provision of advertisements in documents, where the advertisements are based on the content of the documents. The advertisements include a communication reference that can be used to establish a real time communication between a viewer of the advertisement and the advertiser.

U.S. Pat. No. 8,032,427 to Spreen et al. discloses a localization service that provides users with online information on local brick-and-mortar retailers that sell particular products. A search for a particular product at local retailers may be made using search parameters such as search origins, product names, model numbers, product categories, and product attributes. The localization service may provide the user with search results in the form of web pages that list which retailers sell the desired product in the vicinity of the search origin.

U.S. Patent Application Publication No. 2008/0040678 to Crump discloses an interactive map web-based tool, which gives the user the ability to customize their use of a map, using a customized overlay of point of interest information. Drop down lists permit the user to display one or more points of interest by location or class. With such an arrangement a traveler can easily select for display only those particular resources that are of interest to the traveler.

This background information is provided to reveal information believed by the applicant to be of possible relevance to the present invention. No admission is necessarily intended, nor should be construed, that any of the preceding information constitutes prior art against the present invention.

### SUMMARY OF INVENTION

The disclosed invention improves the efficiency of the world wide web in relation to local markets and local businesses. As the problem being solved is inherent to the world wide web, in that its low overhead cost and search engines favor large businesses that are national or international, the solution provided by the disclosed invention is, as a consequence, framed within the world wide web. The disclosed technology focuses on enabling the highest degree of “information flow” between local businesses and shoppers and the by-product of this technology is the creation of a more efficient local search technology for local businesses and shoppers, where their future reliance on multiple search strategies and assembling local market information diminishes over time. The invention disclosed enables shoppers to find, organize and plan their local shopping strategies more effectively through larger, home-based interfaces first and mobile interfaces second.

Disclosed herein is a processor-implemented method for providing local marketplace information to a user, comprising: receiving a location from a user via a user computing device; displaying, on the user computing device, a plurality of vertical categories related to the location; receiving, via the user computing device, a vertical category selection from the displayed vertical categories; displaying, on the user computing device, a plurality of sub-categories for the vertical category selection; receiving, via the user computing device, a sub-category selection from the displayed sub-categories; displaying, on the user computing device, a plurality of business listings for the sub-category selection; and displaying, on the user computing device, concurrently with the display of business listings, a plurality of updates from businesses to which the business listings correspond.

Embodiments of the method may further comprise: displaying, on the user computing device, a plurality of sub-sub-categories for the sub-category selection; and receiving, via the user computing device, a sub-sub-category selection from the displayed sub-sub-categories; wherein the displayed business listings correspond to the sub-sub-category selection.

Embodiments of the method may further comprise: receiving, via a further computing device, a new update on behalf of a business for which a listing is displayed; and displaying, on the user computing device, the new update concurrently with the listing corresponding to the business from which the new update has been received; wherein the new update is displayed in substantially real time compared to when the new update was received.

Embodiments of the method may further comprise: receiving, via one or more further user computing devices, feedback in response to the displayed updates; and displaying the feedback on the user computing device concurrently with the displayed business listings.

Also disclosed herein is a processor-implemented system for providing local marketplace information to a user, comprising: a processor; and computer readable memory storing computer readable instructions, which, when executed by the processor cause the processor to: receive, via a user computing device, a location from a user; display, on the user computing device, a plurality of vertical categories related to the location; receive, via the user computing device, a vertical category selection from the displayed vertical categories; display, on the user computing device, a plurality of sub-categories for the vertical category selection; receive, via the user computing device, a sub-category selection from the displayed sub-categories; display, on the user computing device, a plurality of business listings for the sub-category selection; and display, on the user computing device, concurrently with the display of business listings, a plurality of updates from businesses to which the business listings correspond.

Further disclosed herein is a processor-implemented improvement to the world wide web for providing local marketplace information to a user, comprising: a processor; and computer readable memory storing computer readable instructions, which, when executed by the processor cause the processor to: receive, via a user computing device, a location from a user; display, on the user computing device, a web page comprising a plurality of vertical categories related to the location; receive, via the web page displayed on the user computing device, a vertical category selection from the displayed vertical categories; display, in the web page on the user computing device, a plurality of sub-categories for the vertical category selection; receive, via the web page displayed on the user computing device, a sub-category selection from the displayed sub-categories; display, in the web page on the user computing device, a plurality of business listings for the sub-category selection; and display, in the web page on the user computing device, concurrently with the display of business listings, a plurality of updates from businesses to which the business listings correspond.

The improvement to the world wide web may further cause the processor to: display, in the web page on the user computing device, a plurality of sub-sub-categories for the sub-category selection; receive, via the web page on the user computing device, a sub-sub-category selection from the displayed sub-sub-categories; and display business listings that correspond to the sub-sub-category selection on a further web page that is dedicated to the sub-sub-category selection and the location.

### BRIEF DESCRIPTION OF DRAWINGS

The following drawings illustrate embodiments of the invention, which should not be construed as restricting the scope of the invention in any way.

FIG. 1 is a schematic representation of a screenshot of an embodiment of a processor-implemented invention for providing local marketplace information, showing key features.

FIG. 2 is a schematic representation of a system in accordance with some implementations of the present invention.

FIG. 3 is a schematic representation of a more detailed, computer screenshot according to some embodiments of the present invention.

FIG. 4 is a schematic representation of a dashboard that is intended for use by a business.

FIG. 5 is a schematic representation of a home page of a business.

FIG. 6 is a simplified matrix demonstrating how data is stored and navigated, according to some embodiments of the present invention.

FIG. 7 is a schematic representation of a screenshot for a mobile device, according to some embodiments of the present invention.

FIG. 8 is a flowchart of a process performed by some embodiments of the present invention.

### DESCRIPTION

### A. Glossary

The term “business” is used to refer to an entity that desires to promote itself and/or its wares and/or its services and/or its work. Primarily, it is to be understood to include local stores and service providers with brick and mortar outlets, but it can also include sports teams, research groups, political groups, charities and start-up companies, for example.

The term “firmware” includes, but is not limited to, program code and data used to control and manage the interactions between the various modules of the system.

The term “hardware” includes, but is not limited to, the physical housing for a computer as well as the display screen, connectors, wiring, circuit boards having processor and memory units, power supply, and other electrical components.

The term “internet” refers to the interconnection of computer networks throughout the world.

The term “location” refers to a city or a region within a city, such as a community, a neighborhood, a shopping district or a street.

The term “module” can refer to any component in this invention and to any or all of the features of the invention without limitation. A module may be a software, firmware or hardware module, and may be located in a user device or a server.

The term “network” can include both a mobile network and data network without limiting the term's meaning, and includes the use of wireless (2G, 3G, 4G, WiFi, WiMAX™, Wireless USB (Universal Serial Bus), Zigbee™, Bluetooth™ and satellite), and/or hard wired connections such as internet, ADSL (Asymmetrical Digital Subscriber Line), DSL (Digital Subscriber Line), cable modem, T1, T3, fiber, dial-up modem, television cable, and may include connections to flash memory data cards and/or USB memory sticks where appropriate. A network could also mean dedicated connections between computing devices and electronic components, such as buses for intra-chip communications.

The term “processor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs the steps in the flowcharts, whether they are explicitly described as being executed by the processor or whether the execution thereby is implicit due to the steps being described as performed by code or a module. The processor, if comprised of multiple processors, may be located together or geographically separate from each other. The term includes virtual processors and machine instances as in cloud computing or local virtualization, which are ultimately grounded in physical processors.

The term “real-time” means that changes to the system are made and propagated throughout the system as and when they occur, subject to normal delays related to transmission of information, processing, bandwidth limitations, refresh rates of browsers, and push technology. “Real-time” may therefore be interpreted to mean near real time. While the display of updates is initiated in real-time, they may also remain displayed for a period of time, and may also be retrievable from archives.

The term “software” includes, but is not limited to, program code that performs the computations and manipulations necessary for capturing user inputs, accessing databases, filtering information, combining information and displaying information.

The term “system” when used herein refers to a real-time local marketplace information system, or, in other words, a system for providing local business listings concurrently with the latest updates from those businesses, the system being the subject of the present invention. The businesses may be in the same category but are otherwise generally owned and operated independently from each other.

The term “user” refers to a person who uses the system or interacts with it via a user device. There may be different types of user, such as a user who wishes to only find out information about a business (e.g. a shopper or customer), or a user who wishes to provide information about a business. Users who provide information about a business may be an owner of the business or may be acting on behalf of the business, or they may be users that provide reviews or ratings on the business.

The term “vertical” refers to a vertical market, or a market in which the merchants offer goods and/or services relating to a very particular industry, trade, profession or specialized need. It is to be contrasted with a horizontal market in which goods and services covering a wide range of needs are supplied.

The term “world wide web” refers to the system of documents, information and other electronic content stored on the internet that can be accessed via hyperlinks and uniform resource locators using the computers and networks connected to the internet.

### B. Exemplary Embodiments

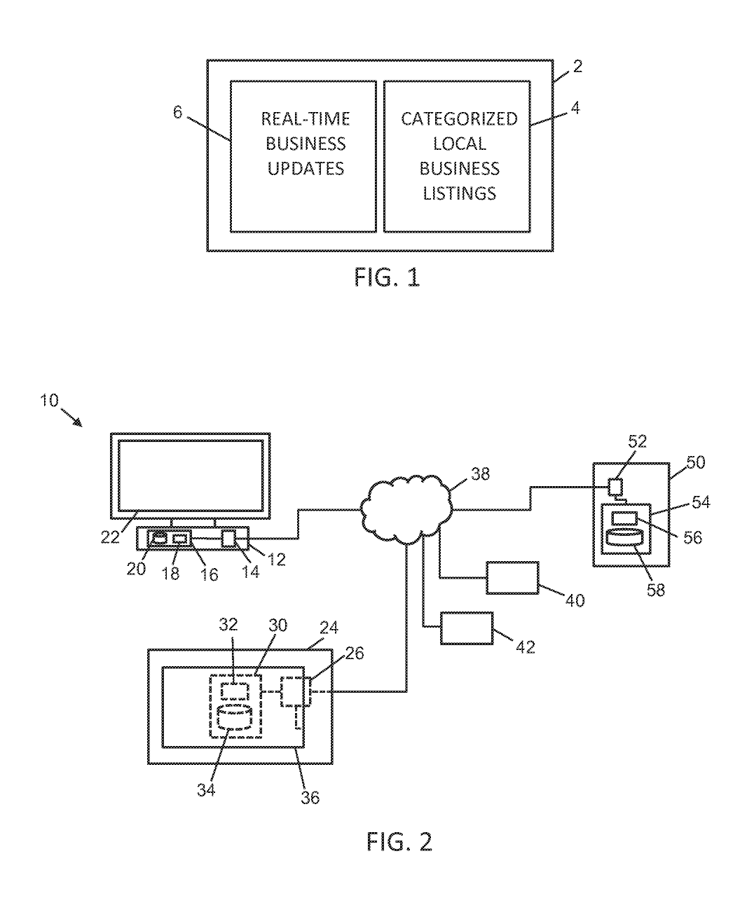

Referring to FIG. 1, the main features of the processor-implemented invention can be seen. In particular, the processor-implemented invention displays, within a single screenshot 2, a list 4 of one or more categorized, local businesses, each business being independent from the others, as well as real-time updates 6 from the businesses. The businesses are typically small to medium sized businesses. As and when one of the businesses that is listed provides an update to the system, it is displayed in the screenshot 2. The result is that a user who is interested in the displayed category of businesses is also able to see the latest information from each of the businesses, without departing from the displayed screen. Such conveniently provided information may relate to special offers or sales, for example, which would not be available to the user using a traditional search engine or traditional online directory.

Referring to FIG. 2, there is shown an exemplary real-time local marketplace information system 10 in accordance with the processor-implemented invention. The system 10 includes or interacts with a user computing device 12, which may be a laptop or desktop computer, for example, or any other electronic device that provides the necessary equivalent functionality to fulfill the requirements of the invention. The user device 12 includes one or more processors 14 which are operably connected to computer readable memory 16 included in the device. The system 10 includes computer readable instructions 18 (e.g. an application) stored in the memory 16 and computer readable data 20, also stored in the memory. The memory 16 may be divided into one or more constituent memories, of the same or different types. The user device 12 includes a display screen 22, operably connected to the processor(s) 14. The display screen 22 may be a traditional screen, a touch screen, a projector, an electronic ink display or any other technological device for displaying information.

The system 10 may include or interact with a further user computing device 24, which may be, for example, a smartphone, a tablet, electronic goggles, a wrist device, other wearable devices, a thin client or any other electronic device that provides the necessary equivalent functionality to fulfill the requirements of the invention. The user device 24 includes one or more processors 26 which are operably connected to computer readable memory 30 included in the device. The system 10 includes computer readable instructions 32 (e.g. a mobile device application) stored in the memory 30 and computer readable data 34, also stored in the memory. The memory 30 may be divided into one or more constituent memories, of the same or different types. The user device 24 includes a display screen 36, operably connected to the processor(s) 26. The display screen 36 may be a traditional screen, a touch screen, a projector, an electronic ink display or any other technological device for displaying information.

The user devices 12, 24 are connected to or into the system via a network 38, which may, for example, be the internet, a telecommunications network, a local area network, a bespoke network or any combination of the foregoing. Communications paths in the network 38 may include any type of point-to-point or broadcast system or systems. Other users may have further user devices 40, 42 with functionally equivalent components to those of device 12 or 24, which may also be part of, or connected to, the system. User devices 40, 42 may be portable or non-portable computing terminals.

The system 10 also includes a server 50, which has one or more processors 52 operably connected to a computer readable memory 54, which stores computer readable instructions 56 and computer readable data 58. Data 58 may be stored in a relational database, for example. Some or all of the computer readable instructions 18, 32, 56 and computer readable data 20, 34, 58 provide the functionality of the system 10 when executed or read by at least some of the processors 14, 26, 58. Computer readable instructions may be broken down into blocks of code or modules.

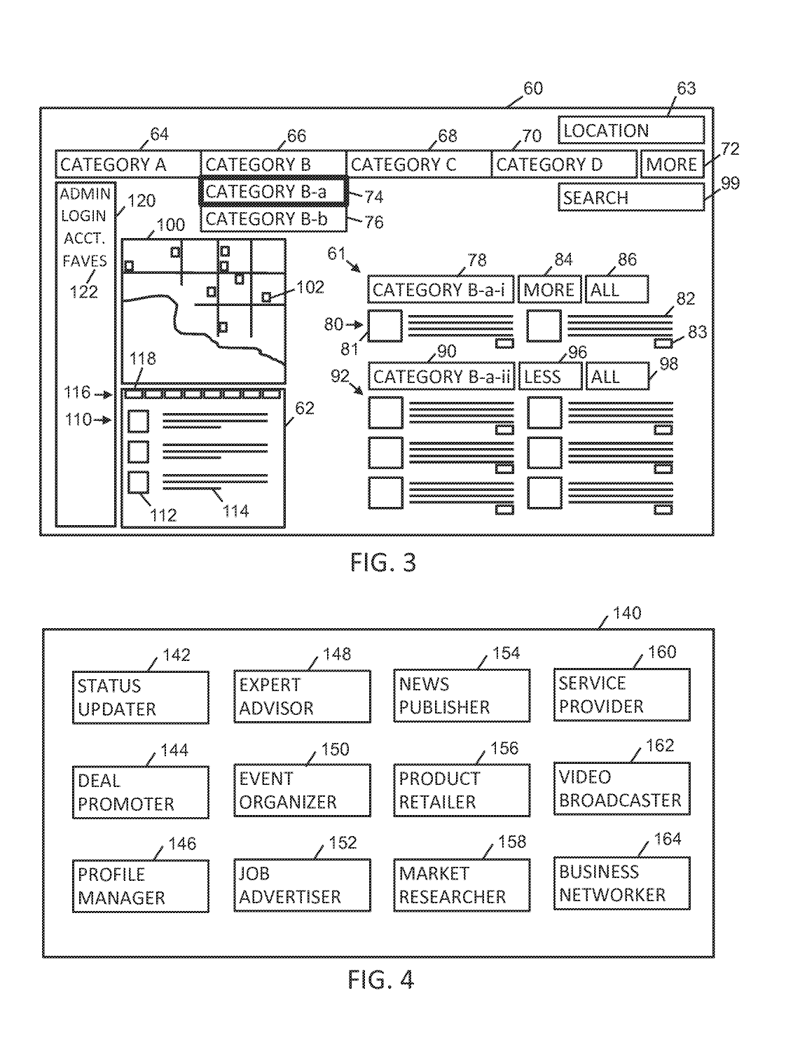

Referring to FIG. 3, a screen shot 60 is shown of an exemplary embodiment of the processor-implemented invention, which may, for example, be displayed in a browser running on the user's computer 12. The key features of the screen shot 60 are the display of a categorized list 61 of local businesses concurrently with the display of real-time updates 62 from the listed businesses. Box 63 is used for selecting the location of interest of the user. The location may be selected from a pull-down menu or it may be typed in or it may be selected using other known means. Once a shopper has selected his geographic market of interest he can easily navigate across vertical (main) categories to find only the relevant businesses within the selected geographic area. This feature results in significant time savings compared to traditional search engines, as users are able to “search” by navigating and browsing, rather than by entering key words.

Based on the location that is selected, a series of vertical categories 64, 66, 68, 70 is displayed. This is, the headings of the vertical categories are displayed. The vertical categories are relevant to the location that has been selected. For example, the vertical categories may be auto repair, bicycles, cameras, hair stylists, grocers, etc. A “More” button 72 can be clicked to bring more vertical categories into view on the display. At least some of the vertical categories that are displayed may be clicked on to display an expanded list of sub-categories. For example, in the current screen shot 60, Category B 66 has been selected and thereby expanded to display the sub-categories B-a 74 and B-b 76. Depending on the embodiment, and of the size of the vertical category B 66, the number of sub-categories may be different to that shown here. Also, the number of sub-categories may be different for each vertical category 64-70. Numbers of vertical categories and sub-categories may vary depending on the location that is selected.

When a drop-down menu of sub-categories 74, 76 is displayed, one of them may be selected, such as sub-category B-a 74 shown here in bold, in order to reveal listings of the businesses within the sub-category. Such businesses may be divided into further categories, or sub-sub-categories, such as Category B-a-i 78. In the example shown, two businesses 80 are listed in Category B-a-i 78. The listing for each business includes a thumbnail 81, which may be a picture or an icon, for example, and some text 82, which may include a business name, an address, opening times, one or more product names, one or more prices, a link to a dedicated business profile page within the website provided by the system, a link to the business's own website, etc. Also included in the text 82, depending on the embodiment, there may be a status update or an indication of whether there is a recent status update or market update in the real-time market update section 62. The time of the latest status update or market update may also be given, and/or the type of market update. For each of the listings 80 there may be a save button 83, which, when clicked or otherwise selected may save the listing to the user's favorites, for example.

Depending on the layout of the screen, one, two or more business listings 80 may be shown under the sub-sub-category heading 78 at the same time. The number of listings may be limited to the first row of listings that have been retrieved from the database 58. The number of listings that are retrieved from the database 58 may be twenty, for example, or any number up to twenty if there are fewer listings available in that particular sub-sub-category in the database. When the user clicks on the More button 84, all twenty listings in the sub-sub-category are displayed, or as many as have been retrieved from the database 58. If the user is interested in viewing all the available listings in the sub-sub-category, then, by clicking on the All button 86, all the listings beyond the twenty that have already been retrieved are obtained from the database 58 and displayed on the screen 60, together with the first twenty. Such a display may result from the user being taken to a dedicated webpage for the particular sub-sub-category and geographic location 63 that has been selected. In that sense, the All button 86 is a selection button for the display of the complete set of listings in the sub-sub-category of interest. In other embodiments, initial limits for the numbers of sub-sub-category listings retrieved from the database 58 may be different from twenty.

When the More button 84 is activated and the additional listings are displayed, the More button changes to a Less button (e.g. button 96 for the sub-sub-category below), which, when activated will reverse the effect of the More button and result in the display, once again, of the initial row of listings 80. When the All button 86 is activated, it and the More button 84 may be changed to a single Less button. Depending on the embodiment implemented, other methods of expanding and contracting the lists of businesses may alternatively be employed.

When a sub-category 74, 76 is selected, all the sub-sub-categories for the selected sub-category are displayed on the screen 60, or if there is not enough room, they may be scrollable. In the example shown, a second sub-sub-category B-a-ii 90 is displayed with its corresponding listings 92. In this example, the More button for the sub-sub-category 90 has been activated and a Less button 96 is displayed. As a result of the corresponding More button having been activated, all the retrieved listings 92 are displayed (here, it is six due to lack of space, but it may be twenty, for example). Also displayed for this sub-sub-category is an All button 98, which, when activated, will cause the display of all the listings in the sub-sub-category B-a-ii 90.

A search field 99 is also displayed in the screen shot 60, which allows users to search within the selected category, sub-category or sub-sub-category. By limiting the search to the selected category, sub-category or sub-sub-category, the search is faster and the results are more accurate than traditional search engines.

Also displayed on the screen 60 is a map 100, which displays miniature thumbnails or other, identifying markers 102 for each of the businesses 80, 92 listed in the sub-sub-categories, 78, 90. The map may be scrollable, expandable and can be zoomed or otherwise be manipulated, as is known in the art. The map may display some, all or more of the businesses whose listings are displayed.

Below the map 100 is the area for real-time market updates 62. In this area, there may be updates 110 from any or all of the businesses listed in the category 64-70 or sub-category 74 that has been selected, or in the sub-sub-category 78, 90 that may be selected. Each update includes a thumbnail 112 of the business and the text 114 of the update. The text 114 may also include the business name, address, phone number, timestamp, a status update etc. The display of the real-time updates 62 is updated as and when a business provides an update to the system 10. The display of the updates changes as and when a different category 64-70 is selected, as and when a different sub-category 74, 76 is selected, as and when a sub-sub-category 78, 90 is expanded or collapsed, so that the displayed updates correspond to the displayed listings. If a specific business listing in a sub-sub-category is selected, then only the updates from that business are displayed. If the displayed listings are filtered due to the user performing a search via the search field 99, then the real time market updates that are displayed are correspondingly filtered in order to match the resulting listings.

The real-time market updates 62 may be divided into different sections. For example, there may be a row of user-selectable tabs 116, where each tab represents a different section. For example, the first tab 118, shown here in bold as selected, may represent general updates that are textual in nature. Other tabs, when selected, may result in the display of video updates, product updates, news, offers, blog entries, events and free items. In some embodiments, the complete up-to-date product listing of a business may be displayed. Businesses may post job openings, contests, reward programs etc. While real-time updates are displayed, the display of one or more preceding updates, or the most-recent updates is also contemplated. Users may communicate with the businesses and other users within the community. For example, users may be able to respond to blog entries, provide reviews on the products and/or the businesses, and may be required to login before being able to do so. As such, the system 10 is a communication system between businesses and customers of the businesses accessible via a single platform.

The screen shot 60 also includes a panel 120 for general management functions, such as administrative actions, login, account management, favorites, etc. Login is optional, depending on how the user desires to use the system 10. Shoppers can save favorite businesses to build a custom geographically and vertically organized database and a custom news feed driven by their selected businesses. As an example, if the user selects the button 122 for favorites, the display area 61 will switch from displaying businesses related to the selected subcategory 74 to displaying the user's favorite businesses, displayed according to their category, sub-category and/or sub-sub-categories. In conjunction with this, the display area 62 will display real time updates from the user's favorite businesses instead of those of the selected sub-category. Also, the map 100 will convert to displaying the locations of the favorite businesses.

Referring to FIG. 4, businesses are provided with a media management dashboard 140, which may be accessed via a browser running on a further computing device connected to the network 38, such as via another device similar to device 12 or 24 for example. Buttons 142-166 on the dashboard may be used by the businesses for inputting market updates in real-time to their dedicated channels. These updates are then broadcast to the business's relevant geo-vertical category homepages, for display in area 61 of screen shot 60. Since the geographic regions are nested, there may be multiple homepages that are relevant to a single business entity. The dashboard 140 may also be used for inputting market updates in real-time to a business's dedicated profile page. Market updates are aggregated for all businesses within a geo-vertical category, sub-category or sub-sub-category and positioned close to, next to or interspersed with the organized rows of business listing data, to provide shoppers with a more complete, organized view of their local market and the opportunities available in it in real-time. Modules or functions that are available through the dashboard 140 include, for example: Status Updater 142; Deal Promoter 144; Profile Manager 146; Expert Advisor 148; Event Organizer 150; Job Advertiser 152; News Publisher 154; Product Retailer 156; Market Researcher 158; Service Provider 160; Video Broadcaster 162; and Business Networker 164.

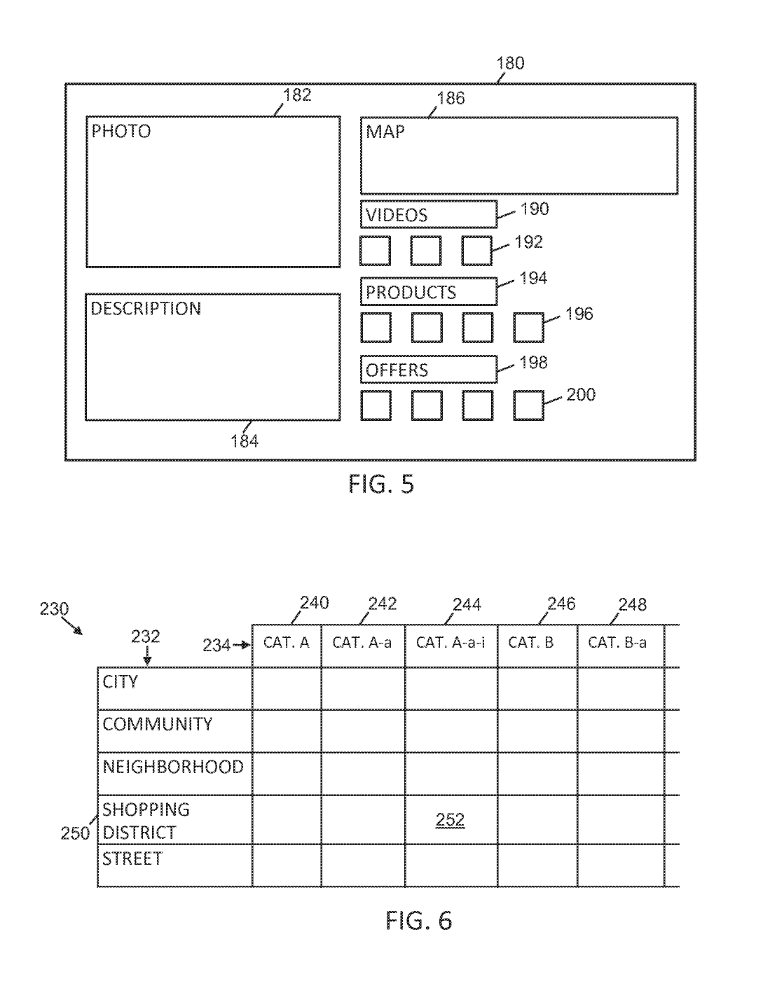

Referring to FIG. 5, a screenshot 180 of a business user's dedicated home page is shown. The page has an area 182 for a photo, an area 184 for a description of the business and a map 186 showing the location of the business. In this example, there is a video section 190 because the business user has uploaded videos, accessible by clicking on one of the thumbnails 192. There is also a products area 194, because the business user has uploaded product information, with further information for each product being accessible by clicking on one of the thumbnails 196. Below this there is an offers area 198, because the business user has uploaded details of offers, with further information for each offer being accessible by clicking on one of the thumbnails 200.

Collapsible and expandable sub-sub-categories within sub-categories, and collapsible sub-categories within main categories, enable the placement of a broader range of business listing results on a single web page, versus tens or hundreds of pages filled with false positives and noise that would be provided by traditional, mainstream search engines. The explicit inclusion of a business in a sub-sub-category ensures that it will be displayed to a user who wants to see all the entries for the sub-sub-category. Such a business may not be visible using traditional search engines, or may be only visible several pages down, due to poor search engine optimization compared to its competitors.

TABLE 1

| | Number of businesses |
|---|---|
| Size of data set | per category |
| World | >1,000,000 |
| Country | <1,000,000 |
| State | <10,000 |
| City | <1,000 |
| Community | <100 |
| Neighborhood | <50 |
| Shopping district | <20 |

Table 1 shows the number of hits that may be obtained when a search is limited (or not) to differently sizes of geographic region. For example, when there is no limit, a worldwide search using a traditional search algorithm may result in over a million hits. At this size of geographic region, it is often hard for the user to find relevant options, and the user is left wanting a recommendation of which options to choose. At the other extreme, at the level of a shopping district, there may be fewer than twenty businesses per category, and they can be presented to a user for comparison so that the user can decide between them.

Referring to FIG. 6, a simplified matrix 230 is shown of how the data is hierarchically stored and navigated. Each row corresponds to geographic locations 232 of decreasing sizes, where each location apart from the first is a subset of the immediately preceding location. For example, the rows may correspond to a city, a community within the city, a neighborhood within the community, a shopping district within the community and a street within the shopping district. Other geographic divisions or names of the locations are also possible. Also, there may be fewer or greater than five geographic divisions. For example, there may be a state level or a country level. For each row of the matrix 230, there is a column corresponding to a hierarchy of business categories 234, shown here as vertical category A 240, sub-category A-a 242 and sub-sub-category A-a-i 244. The matrix may continue with further verticals, such as vertical category B 246, sub-category B-a 248 etc. Now, for example, if a user browses to a particular shopping district 250 and a particular sub-sub-category, such as category A-a-i 244, then the business listings of interest will be found in box 252 of the matrix 230. The system does not need to perform a search in any of the other categories, nor in any of the locations in the rows above the shopping district 250. Box 252 provides the listings of all the businesses of interest to the user.

There is a matrix 230 for each city for which there are business listings in the system 10. Each geographic market and vertical market intersection is represented by a homepage that displays the entire business listing content within a vertical category for that geographic area.

The intersection of geographic market and vertical market categories therefore represents a comprehensive business/shopping category dataset within that geographic market and vertical market category. Local shoppers can navigate to a specific geographic community level and find every business in that community organized by vertical category, sub-category and sub-sub category. Local shoppers can also navigate to a specific vertical category, sub-category or sub-sub category and then select a geographic community level to refine business listings to their geographic area of interest.

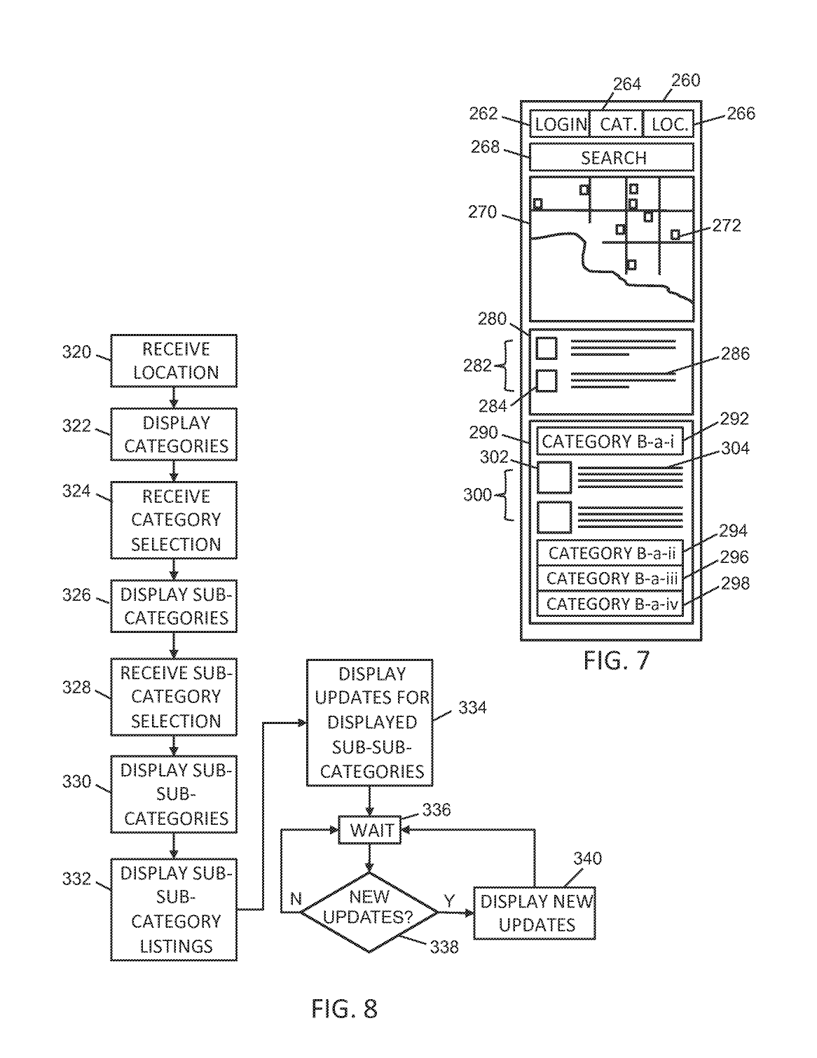

Referring to FIG. 7, a scrollable screen shot 260 is shown that may be displayed on a mobile electronic device 24, such as a smart phone. The various portions of the screen shot may be collapsed and/or expanded for improved display. Across the top area of the screen shot 260, there is a login button 262, a main category selection button 264 and a location selection field 266. Below these, there is a search field 268, which may be used to search within a selected category, whether it be a vertical category, a sub-category or a sub-sub-category. The search function may be augmented by a voice operated search component. Next is the map 270, which displays icons or thumbnails 272 at the locations of the displayed business listings 290. Below the map 270 is the real-time updates section 280, which displays updates 282 each having thumbnails 284 of the corresponding businesses and textual updates 286 from those businesses. The bottom section 290 displays the sub-sub-categories 292, 294, 296, 298. The sub-sub-category B-a-i 292 has been selected by the user and as such is expanded to show individual business listings 300, each including a thumbnail 302 and textual portion 304. Sections 270, 280, 290 of the screen shot 260 may be separately scrollable, and/or the whole screen shot may be scrollable. Individual sections of the display may be expandable and collapsible.

The system 10 is best utilized through a combination of both online (e.g. desktop computer or laptop 12) and mobile (e.g. tablet or mobile phone 24) interfaces. This is because a user can research the available businesses at home on a larger screen, select one or more favorites, and then access the very latest updates from those favorites while en route to the businesses.

Referring to FIG. 8, a flowchart is shown of a processor-implemented method performed by an exemplary embodiment of the system 10. In step 320, the system 10 receives a location from a user via computer 12, for example. The location is specified as a particular city, for example, or a smaller region within a particular city, such as a community, a neighborhood, a shopping district or a street. In step 322, the system 10 displays, on computer 12, the vertical category headings of businesses that are operating in the selected location. In step 324, the system receives, via computer 12, a selection from the user of one of the vertical categories. In step 326, the system 10 displays on computer 12, the sub-category headings that are available for the selected vertical category. In step 328, the system receives, via computer 12, a selection from the user of one of the sub-categories. In step 330, the system 10 displays, on computer 12, the sub-sub-category headings for the selected sub-category. In step 332, the system displays one or more listings of businesses in one or more of the displayed sub-sub-categories. The number of listings that are displayed may be varied by the user, who may input to the system 10 a request to display more or all of the listings in a given sub-sub-category.

In step 334, the system 10 displays one or more of the latest updates for the listings that are displayed. In step 336, the system 10 waits a predetermined amount of time and then, in step 338, checks whether there are any new updates that have been entered by the business or a user acting on behalf of the business. Thee amounts of time the system waits may depend on the available processing power and bandwidth, and may be a fraction of a second or several minutes, for example. In step 340, the system 10 displays the new updates and then waits at step 336 again before once again checking for new updates in step 338. The user may change the selection of the sub-category or category, which will cause the process to jump to step 328 or 324 respectively. The process terminates when the user closes the browser that is being used on device 12 for the display of categories, listings and updates.

### C. Industrial Applicability

The disclosed processor-implemented invention provides a comprehensive solution for improving the performance of inefficient local markets, which is in large part due to a lack of efficient local search and information sharing technologies for local businesses and shoppers. Various embodiments of the disclosed invention provide one or more of the following benefits:

It may provide an efficient online solution for local businesses and shoppers for promoting, finding and sharing local market information, which is more efficient than traditional local search technologies. This is achieved by using a combination of: database and interface design; pre-determined database calls; and co-mingling of static and dynamically generated market information. It improves upon current local search technology, by enabling real-time sharing of “market signals” and/or enabling social engagement between local businesses and shoppers.

Compared to traditional, keyword based search engines, it may provide a reduction of false-positive search results and noise by organizing references that would be false-positives and making them available as alternative, related-category search results. Such alternative results may be classified in different sub-sub-categories or sub-categories to the one the user has currently selected. The result is that the user can more easily focus on the references of interest, without having to read through and mentally eliminate references that are not applicable. Results that would be classified as false negatives by traditional search engines are explicitly included in the sub-sub-category listings of interest, on the same page as other entries in the sub-sub-category. Results that may be considered to be poor matches by traditional search engines also appear on the same page as the other entries in the sub-sub-category, instead of being displayed several pages down.

It may eliminate the requirement for tracking of shoppers' online activities to determine the set of “optimal” search results for a user based on their perceived preferences. The disclosed system enables the user to navigate and find local market information more efficiently, which, in itself, reveals user preferences to businesses in real-time.

It may reduce the need for typing and re-entering key-words to conduct multiple, related-category searches after the initial search. Typing activity is significantly reduced and replaced by clicking/tapping activity as a tool for finding complete data sets of local market options across multiple categories.

It may increase the potential to generate revenue from a wider range of revenue drivers than purely search-related drivers.

It may provide a shift away from search-based revenue drivers to communication-based revenue drivers. It may demonstrate to competitors why an information-sharing based local advertising system is more efficient and potentially more lucrative than a search-based local advertising system.

The geo-vertical homepage design of the invention unlocks the potential for monetizing alternative revenue drivers from different categories of market information updates (status updates, video updates, news releases, blog posts, event posts, deals/offers etc.). The key to monetizing an information update is based on the ability to command an audience of targeted shoppers who view the update. By positioning comprehensive organized business listing search results next to real-time market information updates generated by those businesses, the invention converts search-based activity into browsing/social engagement activity which drives greater value (time saving, cost-saving, knowledge-improving) for both local businesses and shoppers.

### D. Variations

The system can be applied to other geographical and vertical marketplace categories to improve the efficiency of search and information exchange between market participants, and markets may be public or private.

For example, the system 10 may be used in the market for high school sports, which is a public marketplace example. The problem is that high school sports teams wish to attract sports fans to increase their fan base and potentially drive revenue from ticket sales. Sports fans wish to attend sporting events for entertainment and follow sports news. The system 10 can facilitate a more efficient market for matching local high school sports teams, which are effectively businesses, with local sports fans. Schools are organized in the system 10 by geographic hierarchy: city>community>neighborhood. Sports are organized by sporting category, for example: baseball, basketball, football, hockey, rugby, soccer etc. The intersection of geographic and sporting categories then offers high school sports teams, and also local sports teams, a destination for finding schedules, video and news highlights, statistics and interviews.

Another example is in the field of medical research, which is a private marketplace example. Here, the problem is that medical researchers are scattered around the world focused on advancing the state of their research by sharing information with other researchers and attracting funding. Researchers are organized in the system 10 by geography: country>state/province>city and by medical research category, sub-categories and sub-sub-categories. For example, a field of research may be neuroscience, which may be sub-categorized by the branches: affective; behavioral; cellular; clinical; etc. and/or sub-categorized by disease, such as Alzheimer's, autism, etc. Another field of research may be cancer, which may be sub-categorized into carcinoma, sarcoma, etc. Other fields of research may be diabetes, spinal chord, etc.

Yet another example of the use of the system is in the field of political campaigning, which is a public marketplace example. The problem in this field is that political campaigners and constituents wish to promote and engage with local constituents who wish to evaluate and engage with the local political campaigners. Categorizing political campaigners by geographic location and political party enables the creation of localized information sharing hubs between these parties.

A further example of the use of the system 10 is in private funding, which is a public marketplace example. The problem is that start-up companies wish to promote their business opportunities to investors and other funding providers and investors wish to identify early stage investment opportunities by category and geographic location. Categorizing start-up companies by geographic location and industry category enables the creation of localized information sharing hubs between these parties.

Throughout the description, specific details have been set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid state memories, etc. The methods may alternatively be embodied partly or wholly in specialized computer hardware, such as ASIC or FPGA circuitry.

In general, unless otherwise indicated, singular elements may be in the plural and vice versa with no loss of generality. The use of the masculine can refer to masculine, feminine or both.

It will be clear to one having skill in the art that variations to the specific details disclosed herein can be made, resulting in other embodiments that are within the scope of the invention disclosed. Steps in the flowcharts may be performed in a different order, other steps may be added, or one or more may be removed without altering the main function of the system. Screen shots may show more or less than the examples given herein. Regions of display in the screen shots may be arranged differently. Relative proportions of areas of the screen shots may be different. All parameters and relative dimensions described herein are examples only and actual values of such depend on the specific embodiment. Accordingly, the scope of the invention is to be construed in accordance with the substance defined by the following claims.

1. A processor-implemented method for providing local marketplace information to a user, comprising:
receiving a location from a user via a user computing device;
displaying, on the user computing device, a plurality of vertical categories related to the location;
receiving, via the user computing device, a vertical category selection from the displayed vertical categories;
displaying, on the user computing device, a plurality of sub-categories for the vertical category selection;
receiving, via the user computing device, a sub-category selection from the displayed sub-categories;
displaying, on the user computing device, a plurality of business listings for the sub-category selection; and
displaying, on the user computing device, concurrently with the display of business listings, a plurality of updates from businesses to which the business listings correspond.

2. The method of claim 1, further comprising:
displaying, on the user computing device, a plurality of sub-sub-categories for the sub-category selection; and
receiving, via the user computing device, a sub-sub-category selection from the displayed sub-sub-categories;
wherein the displayed business listings correspond to the sub-sub-category selection.

3. The method of claim 2, further comprising:
receiving, via the user computing device, a search term;
performing a search for the search term in the selected sub-sub-category;
wherein the displayed business listings further correspond to the search term.

4. The method of claim 2, wherein the display of the business listings is on a web page that is dedicated to the sub-sub-category selection and the location.

5. The method of claim 1, wherein the updates are displayed in real time.

6. The method of claim 1, further comprising:
receiving, via a further computing device, a new update on behalf of a business for which a listing is displayed; and
displaying, on the user computing device, the new update concurrently with the listing corresponding to the business from which the new update has been received;
wherein the new update is displayed in substantially real time compared to when the new update was received.

7. The method of claim 1, wherein the updates relate to one of more of news releases, blog entries, video updates, textual updates, event advertisement, product information, service information, job postings, brand information, contests, rewards, offers, free stuff or sales.

8. The method of claim 1, further comprising:
receiving, via one or more further user computing devices, feedback in response to the displayed updates; and
displaying the feedback on the user computing device concurrently with the displayed business listings.

9. The method of claim 1, further comprising:
displaying, on the user computing device, a map of the listed businesses concurrently with the display of the business listings.

10. A processor-implemented system for providing local marketplace information to a user, comprising:
a processor; and
computer readable memory storing computer readable instructions, which, when executed by the processor cause the processor to:
receive, via a user computing device, a location from a user;
display, on the user computing device, a plurality of vertical categories related to the location;
receive, via the user computing device, a vertical category selection from the displayed vertical categories;
display, on the user computing device, a plurality of sub-categories for the vertical category selection;
receive, via the user computing device, a sub-category selection from the displayed sub-categories;
display, on the user computing device, a plurality of business listings for the sub-category selection; and
display, on the user computing device, concurrently with the display of business listings, a plurality of updates from businesses to which the business listings correspond.

11. The system of claim 10, wherein execution of the computer readable instructions further causes the processor to:
display, on the user computing device, a plurality of sub-sub-categories for the sub-category selection; and
receive, via the user computing device, a sub-sub-category selection from the displayed sub-sub-categories;
wherein the displayed business listings correspond to the sub-sub-category selection.

12. The system of claim 11, wherein execution of the computer readable instructions further causes the processor to:
receive, via the user computing device, a search term; and
perform a search for the search term in the selected sub-sub-category;
wherein the displayed business listings further correspond to the search term.

13. The system of claim 11, wherein the display of the business listings is on a web page that is dedicated to the sub-sub-category selection and the location.

14. The system of claim 10, wherein the updates are displayed in real time.

15. The system of claim 10, wherein execution of the computer readable instructions further causes the processor to:
receive, via a further computing device, a new update on behalf of a business for which a listing is displayed; and
display, on the user computing device, the new update concurrently with the listing corresponding to the business from which the new update has been received;
wherein the new update is displayed in substantially real time compared to when the new update was received.

16. The system of claim 10, wherein the updates relate to one of more of news releases, blog entries, video updates, textual updates, event advertisement, product information, service information, job postings, brand information, contests, rewards, offers, free stuff or sales.

17. The system of claim 10, wherein execution of the computer readable instructions further causes the processor to:
receive, via one or more further user computing devices, feedback in response to the displayed updates; and
display the feedback on the user computing device concurrently with the displayed business listings.

18. The system of claim 10, wherein execution of the computer readable instructions further causes the processor to:
display, on the user computing device, a map of the listed businesses concurrently with the display of the business listings.

19. A processor-implemented improvement to the world wide web for providing local marketplace information to a user, comprising:
a processor; and
computer readable memory storing computer readable instructions, which, when executed by the processor cause the processor to:
receive, via a user computing device, a location from a user;
display, on the user computing device, a web page comprising a plurality of vertical categories related to the location;
receive, via the web page displayed on the user computing device, a vertical category selection from the displayed vertical categories;
display, in the web page on the user computing device, a plurality of sub-categories for the vertical category selection;
receive, via the web page displayed on the user computing device, a sub-category selection from the displayed sub-categories;
display, in the web page on the user computing device, a plurality of business listings for the sub-category selection; and
display, in the web page on the user computing device, concurrently with the display of business listings, a plurality of updates from businesses to which the business listings correspond.

20. The improvement to the world wide web of claim 19, wherein execution of the computer readable instructions further causes the processor to:
display, in the web page on the user computing device, a plurality of sub-sub-categories for the sub-category selection;
receive, via the web page on the user computing device, a sub-sub-category selection from the displayed sub-sub-categories; and
display business listings that correspond to the sub-sub-category selection on a further web page that is dedicated to the sub-sub-category selection and the location.
